(19) United States
(12) Patent Application Publication
(10) Pub. No.: US 2008/0160992 A1
(43) Pub. Date: Jul. 3, 2008

(54) HANDSET TRANSMIT ANTENNA DIVERSITY IN MOBILE SATELLITE SYSTEMS

(75) Inventor: Ahmad Jalali, Rancho Santa Fe, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/771,927

(22) Filed: Jun. 29, 2007

Related U.S. Application Data
(60) Provisional application No. 60/818,143, filed on Jun. 30, 2006.

(51) Int. Cl. H04Q 7/20

(52) U.S. Cl. 455/427

(57) ABSTRACT

A wireless communication device (WCD) used as a satellite telephone is provided with multiple antennas for communicating with its satellites. If signal quality is determined to be poor, then an evaluation is made as to whether switching antennas will result in an improvement in the communication link between the WCD and the satellite.

### CLAIM OF PRIORITY UNDER 35 U.S.C. §119

The present Application for Patent claims priority to Provisional Application No. 60/818,143 entitled “Handset Transmit Antenna Diversity in Mobile Satellite Systems” filed Jun. 30, 2006, and assigned to the assignee hereof and hereby expressly incorporated by reference herein.

### BACKGROUND

1. Field

This invention relates to on-ground beam forming to enhance gain to a desired user.

2. Background

Various satellite communication systems have been developed over the years. One early system architecture is referred to as Time Division Multiple Access (TDMA) and is characterized by assignment of time slots in a communication channel to each of a plurality of terminals, and with communication with the terminals taking place in the specifically assigned time slots. An improved system architecture is referred to as Code Division Multiple Access (CDMA). CDMA based communication systems generally provide greater bandwidth efficiency than do TDMA based communication systems.

In general, signal strength is a critical factor in establishing a communication link with good quality of service (QoS). In the case of satellite communications with multiple subscribers, the signal strength provided to subscribers' wireless communication devices (WCDs) by the satellite and by the WCDs to the satellite is limited. In addition, because of bandwidth constraints, satellite systems are divided into plural beams, which are focused air interfaces of limited geographical area. Wireless links typically require a transmit power margin to compensate for occasional fades caused by multipath signal propagation. In the satellite case, the fading is primarily due to the single ground bounce ray. The reflection from the ground and the line of sight signal in some cases add destructively causing fading in the received signal at the handset and at the gateway. One technique to reduce the transmit power requirement of the handset is to employ diversity techniques on the Return Link (RL) in order to reduce the required fade margin.

Communications over a satellite system typically involve a user's wireless communication device (WCD) used as a handset. These WCDs generally have a small form factor of the same size as the cellular phones. Such small handsets have limited transmit power and have antennas with small gains toward the satellite. Closing a link to the satellite using small form factor handsets is challenging due to large path losses to the satellite and small transmit power from the handset in the satellite direction. There is additional loss of power due to the linear nature of the small handset antennas. Also since antennas on satellite phones may have a large gain toward the ground, the ground bounce will be picked up by a large antenna gain resulting in occasional fades when added out of phase to the line of sight signal. Therefore, it is desired to provide techniques to increase the robustness of the link.

### SUMMARY

According to the present invention, signal coverage is enhanced by establishing a communication link, comparing signal propagation pathways in the communication link and selecting one of the pathways according to a measured signal quality. This may be accomplished by comparing and selecting the signal propagation pathways by selecting an antenna on the user's wireless communication device (WCD). In one particular configuration, this includes selecting an antenna on the user's WCD, and effecting the selection through the user's WCD.

In one particular aspect of the invention, the selection of the signal pathway includes receiving a signal and determining a signal quality value of the signal. If the signal quality value falls below a threshold, a change in antennas is made. A subsequent signal is then received from the remote communication link and a selection of the signals is made in accordance with the signal quality value.

In a further aspect of the invention, a WCD includes an RF circuit that separately establishes a communication link through two antennas. A circuit obtains a comparison of a measured signal quality through signal propagation pathways in the communication link as obtained by switching between the at least two antennas, and an antenna switching circuit switches between the at least two antennas in response to a comparison of the measured quality.

In another aspect of the invention, a WCD used in satellite communication includes a circuit that obtains a measured signal quality in a communication link and a circuit that determines if the measured signal value falls below a predetermined threshold indicating low signal quality. An annunciator circuit provides an indication to the user of the low signal quality, such that a change in a signal metric related to signal quality results in a change in the indication to the user perceptible by the user. This provides the user with an indication for positioning the WCD in a manner to improve the signal quality.

### BRIEF DESCRIPTION OF THE DRAWINGS

The features, nature, and advantages of the present invention will become more apparent from the detailed description set forth below when taken in conjunction with the drawings in which like reference characters identify corresponding items throughout and wherein:

FIG. 1 is a diagram illustrating an example of a wireless communication network.

FIG. 2 is a diagram showing a wireless communication device (WCD), employing multiple antennas in accordance with the invention.

FIG. 3 is a schematic block diagram of a WCD constructed in accordance with the present invention.

FIG. 4 is a schematic block diagram describing the operation of the invention.

FIG. 5 is a block diagram depicting a technique for enhancing coverage in accordance with the present invention.

FIG. 6 is a schematic block diagram showing the operational configuration of circuit device for use with a satellite communication system constructed in accordance with the present invention.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

### Overview

According to the present invention, a wireless communication device (WCD) is equipped with spatially distributed antennas. The slight change in the signal path resulting from switching the antennas can be used to enhance reception and reduce the effects of localized dead spots. This helps compensate for occasional fades caused by multipath interference and other signal propagation anomalies.

In channels where the rate of change if fade is high, transmit antenna techniques are employed to minimize the fading by compensating for multipath fades. One such technique includes processing that inverse multiplexes the encoded bits into two or more streams, with each stream being communicated through a different antenna. The encoded bit streams sent on the different antennas are usually chosen to be orthogonal such as to not create interference to each other. If the fade of the channel is very slow such as the case where the user is standing still, then an antenna selection/switching scheme can have better performance. In this arrangement, the gateway or base station that receives the handset's transmitted signal on the return link instructs the handset to switch to another antenna when it determines that the other antenna may have a stronger signal.

The invention takes advantage of the fact that ground bounce is a significant component of a signal path in satellite communication. The ground bounce exaggerates the effect of a small difference in the position of the WCD's antennas, such that a selection between two antennas can be determinative as far as quality of service (QoS) is concerned. In addition to ground bounce, it is believed that other factors may affect the communication link. By way of example, if the WCD is held by the user in the manner of a handset, the proximity of the antenna to the user's body may significantly affect the signal.

One criterion to instruct the handset to switch its transmit antenna would be when the received signal from the handset falls below a threshold. The gateway would send one or more bits on the forward link (FL) or downlink to the handset instructing it to switch to another antenna. If the signal on the new antenna is adequate then the handset is left to continue transmitting on the new antenna, otherwise the handset is instructed to switch back to the old antenna.

In the case of the signals to both antennas being inadequate, other measures may be taken. One case calling for alternative measures would be the received signal level on the uplink being inadequate on both antennas. If the received signal level on neither antenna is adequate then a signal may be sent to the handset instructing it to play an audible signal such as a tone to the user. The tone in turn instructs the user to move his/her head and/or location. As the user moves, one or both antennas may come out of fade. The audible signal can be any convenient signal by which the user is informed of signal status.

Since the user has a direct and understandable interest in establishing a good signal path, it is advantageous to include the user in the antenna selection function. This can be performed, for example, by providing audio feedback such as a tone or other noise, and changing the tone or noise according to the signal strength. According to one feature, the user is provided with a tone which indicates a weak signal condition or other signal quality condition such as SINR (signal to interference and noise ratio). The tone also provides an indication of the relative strength of the signal, which provides the user with an audio indication of the signal strength. The tone can be automatically activated, for example in response to a poor signal quality condition, or can be activated by user request. It is possible to use one criterion, such as SINR to indicate a poor signal condition, while providing a tone in response to a more easily measured signal quality, such as signal strength. If the signal quality metric is below a threshold the tone would be emitted so that the user may respond by turning to point the WCD in a different direction. This would continue until the signal strength is above the threshold. Alternatively the frequency of tone can change to indicate whether signal strength or other signal metric is increasing or decreasing to allow the user to determine the strongest direction to point the phone.

If multiple antennas are provided on the same WCD, the WCD is able to obtain data concerning the difference in signal strength or signal quality resulting from switching between the antennas, and can infer that a movement by the user can provide further changes. In that case the criteria for the tone can be a combination of one or more of user enablement of the feature, weak signal reception, poor signal quality, or a signal condition in combination with a predetermined differentiation between signal quality measurements resulting from switching between the antennas.

If a single antenna is used, or if switching between the multiple antennas does not provide a significant improvement in the communication link, the notification of the user of a weak signal provides the user with a tool by which the user can reposition the WCD to improve reception. In the case of an audible signal, the user is able to make the adjustments without moving the WCD away from a position suitable for voice communication (e.g., the user's ear if used as a handset).

The two or more antennas on the handsets are advantageously designed such that the phase differential between the line of sight and specular components for the two antennas be large enough to provide diversity against fading caused by the ground bounce. One possible combination of antennas would be two monopole antennas, one at each end of the phone. One monopole is pulled up out of the phone, whereas the other monopole that is placed at the bottom of the phone is pulled down. The two antennas' phase centers are designed such that there is at least ¼ wavelength of distance between them. The ¼ wavelength phase center difference ensures that the phase differential between the line of sight and the specular signal components for the two antennas be different enough to create diversity against ground bounce induced multipath.

While multiple antennas for communication with satellite systems are described, it is additionally possible to combine the multiple antennas with external antennas and antennas for other wireless services, such as terrestrial wireless communication services, or to use the additional satellite antennas for non-satellite services.

### Operational Environment

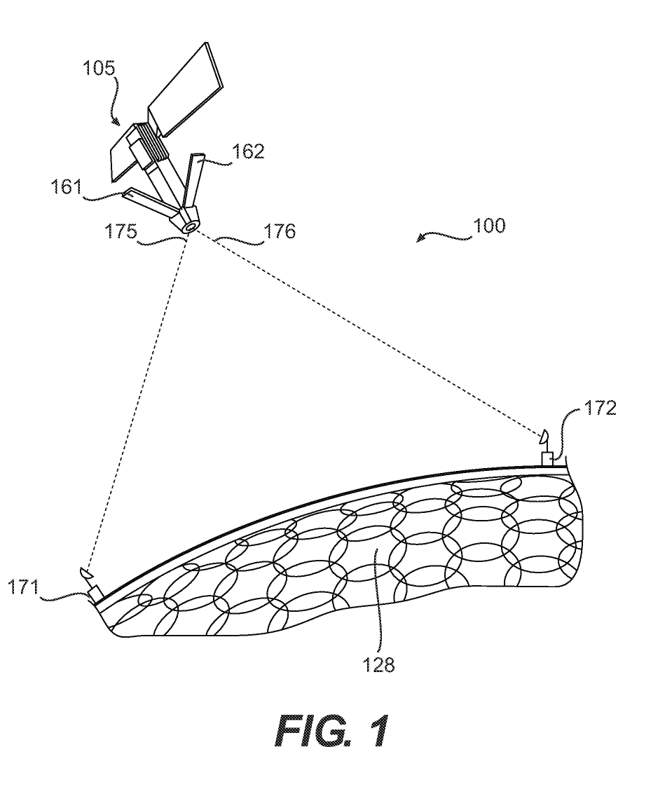

FIG. 1 is a diagram illustrating an example of a wireless communication network 100. In the figure, a satellite communication system uses one or more satellites 105 which provide a signal coverage pattern using separate beams corresponding to coverage areas, such as coverage area 128. The beams are established by primary lobes of directional antenna patterns from subscriber communication antennas 161, 162 on the satellites 105. While actual physical reflectors that are different toward different users are shown, there are alternate implementations which provide different signal coverage patterns for different coverage areas. One example is a physical reflector having multiple feeds, i.e a phased array antenna.

Frequency reuse allows satellites to communicate with a number of ground stations using the same frequency, by transmitting in narrow beams pointed toward each of the stations. Beam widths can be adjusted to cover footprints which can be limited to small geographical areas, so that two stations far enough apart can receive different messages transmitted on the same frequency. Satellite antennas have been designed to transmit several beams in different directions, using the same reflector, for example by use of a phased array antenna. Techniques for controlling beam footprints include movable and reconfigurable antennas; shaped reflectors; circular and linear polarization antenna design; dynamic beam forming. As a result, it is possible to substantially change the signal propagation for different users.

The beam 128 is used to communicate with subscribers through wireless communication devices (WCDs, not shown). In addition to the beams (e.g., beam 128), the satellite 105 communicates through one or more gateways, represented by ground stations 171, 172, typically through gateway antennas 175, 176, which are separate from the subscriber communication antennas 161, 162.

In order for satellite communication to take place, a link must be established between the satellite 105 and a WCD. In doing so, the signal received by the satellite 105 is evaluated, either by measuring circuitry on the satellite 105 or as a signal relayed through a backhaul through one of the base stations 171, 172.

### Selection of Signals

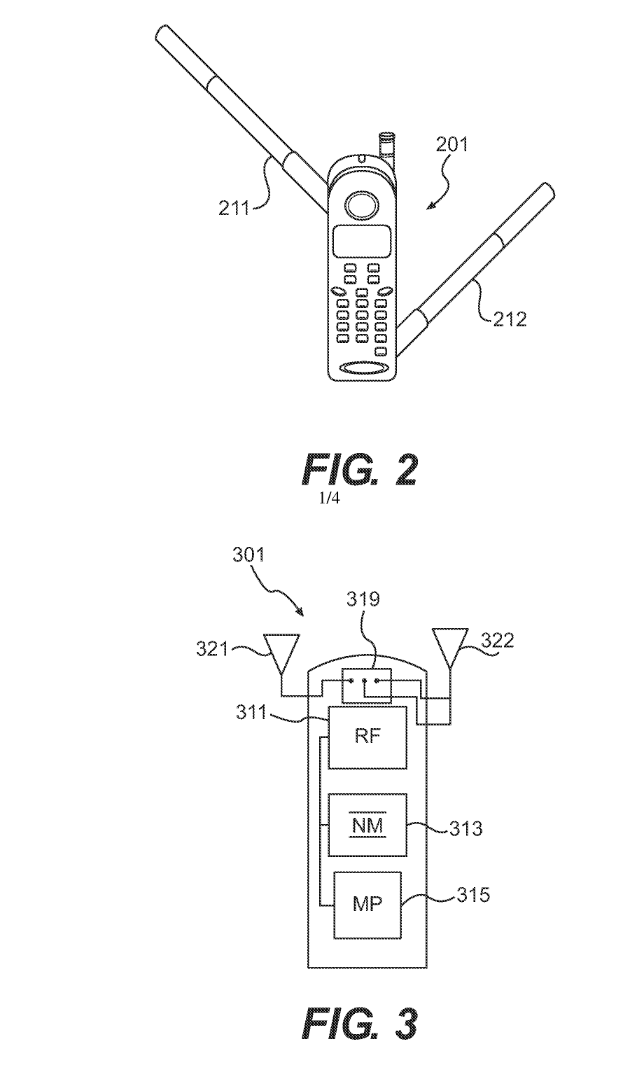

FIG. 2 is a diagram showing a WCD 201, employing multiple antennas 211, 212 in accordance with the invention. The antennas 211, 212 are generally fixed to the WCD 201, although provision can be made to detach and extend the connection from one of the antennas 212 so that it is located further from the other antenna 211. Unless one of the antennas 211, 212 is detached, both antennas 211, 212 are in close proximity to one another.

FIG. 3 is a schematic block diagram of a WCD 301 constructed in accordance with the present invention. The WCD 301 includes an RF circuit 311, for communicating with the satellite, and processing circuitry 313 for processing the communications. By way of example, processing circuitry can include spreaders, despreaders and related logic. The WCD 301 includes a processor 315 that performs control functions, although in many cases the processor 315 is integrated with the processing circuitry 313 and may be further integrated with the RF circuit 311. An antenna switching circuit 319 is used to select between two antennas 321, 322.

### Functional Operation

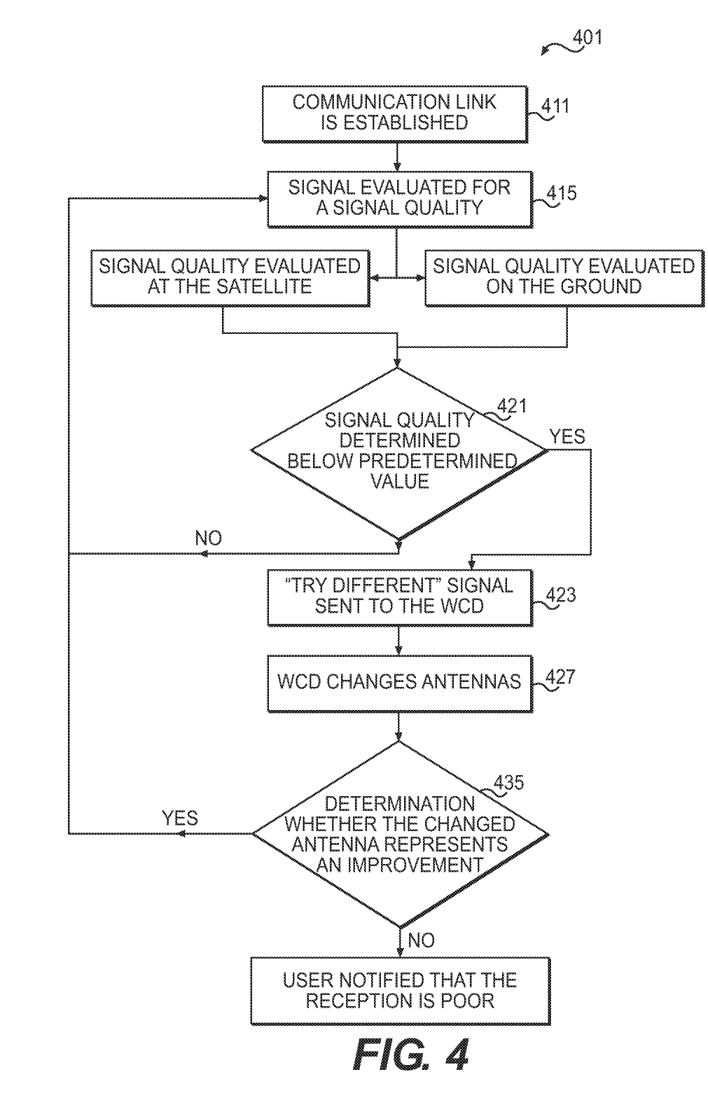

FIG. 4 is a schematic block diagram 401 describing the operation of the invention. A communication link with a WCD 201 (FIG. 2) and the satellite 105 (FIG. 1) is established (step 411). The signal is then evaluated for a signal quality (step 415). The signal quality can be evaluated either at the satellite 105 or on the ground, and can use any convenient measure for signal quality. If the signal quality is determined to be below a predetermined value (step 421) or otherwise is determined to require improvement, a “try different” signal is sent to the WCD 201 (step 423). In response the WCD 201 changes antennas (step 427) used to communicate with the satellite 105, and the procedure of evaluating the signal (step 415) is repeated and a determination (step 435) is made as to whether the changed antenna represents an improvement. The signal evaluation procedure (step 415) is repeated periodically in order to accommodate significant movement of the WCD 201 and the satellite 105.

The user can be notified that the reception is poor, as determined in steps 415-435. This notification may be in the form of a tone or other notification technique. In that case, the antennas 211, 212 may be switched along with the user making small changes in the position of the WCD 201.

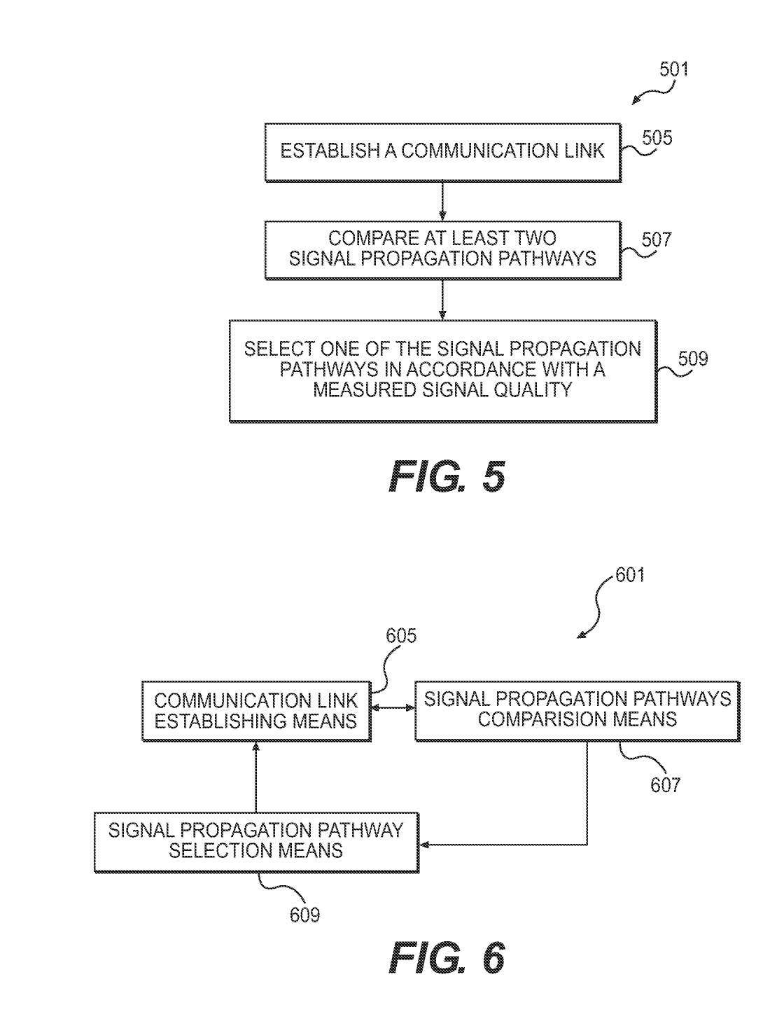

FIG. 5 is a block diagram depicting a technique 501 for enhancing coverage in accordance with the present invention. A communication link is established (step 505). At least two signal propagation pathways are compared (step 507), and one of the signal propagation pathways is selected (step 509) in accordance with a measured signal quality.

Those skilled in the art will appreciate that the various illustrative logical blocks, modules, circuits, and algorithms described in connection with the embodiments disclosed herein may be implemented as electronic hardware, computer software, or combinations of both. To clearly illustrate this interchangeability of hardware and software, various illustrative components, blocks, modules, circuits, and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

FIG. 6 is a schematic block diagram showing the operational configuration of circuit device 601 for use with a satellite communication system constructed in accordance with the present invention. The configuration includes communication link establishing means 605 and signal propagation pathway comparison means 607, for comparing means at least two signal pathways in the communication link. A signal selection means 609 is used to select one of the signal propagation pathways in accordance with a measured signal quality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, microprocessor, or state machine. A processor may also be implemented as a combination of computing devices, e.g., a combination of a DSP and a microprocessor, a plurality of microprocessors, one or more microprocessors in conjunction with a DSP core, or any other such configuration.

The methods or algorithms described in connection with the embodiments disclosed herein may be embodied directly in hardware, in a software module executed by a microprocessor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. For example, one or more elements can be rearranged and/or combined, or additional elements may be added. Thus, the present invention is not intended to be limited to the embodiments shown herein but is to be accorded the widest scope consistent with the principles and novel features disclosed herein.

What is claimed is:

1. In a satellite system, a method for enhancing coverage, the method comprising:
establishing a communication link;
comparing at least two signal propagation pathways in the communication link; and
selecting one of the signal propagation pathways in accordance with a measured signal quality.

2. The method of claim 1, further comprising comparing and selecting the signal propagation pathways by selecting an antenna on a user's wireless communication device (WCD).

3. The method of claim 1, further comprising comparing and selecting the signal propagation pathways by selecting an antenna on a user's wireless communication device (WCD), and effecting the selection through the user's WCD.

4. The method of claim 1, comprising:
receiving a signal from a user's wireless communication device (WCD);
determining a signal quality value from a first signal from the WCD;
in the case of the signal quality value having a value below a predetermined threshold, issuing a low signal value message;
receiving a subsequent signal from the WCD;
comparing and selecting the signals in accordance with the signal quality value;
propagation pathways by selecting an antenna on the user's WCD; and
effecting the selection through the WCD.

5. The method of claim 1, comprising:
receiving a signal from a remote communication link;
determining a signal quality value of the signal received from the remote communication link;
in the case of the signal quality value having a value below a predetermined threshold, effecting a change in antennas
receiving a subsequent signal from the remote communication link; and
comparing and selecting the signals in accordance with the signal quality value.

6. The method of claim 1, comprising:
establishing a remote communication link;
obtaining a determination of a signal quality value of the signal received by a receiving communication device in the established communication link;
in the case of the signal quality value having a value below a predetermined threshold, effecting a change in antennas;
obtaining a determination of a second signal quality value of a subsequent signal received by a receiving communication device in the established communication link; and
comparing and selecting the signals in accordance with the signal quality value.

7. The method of claim 1, further comprising
combining received signals in the communication link; and
using the combined signals in the communication link.

8. The method of claim 7, comprising using the combined signals in a MIMO communication link.

9. The method of claim 7, comprising using a plurality of different signals for communicating with the user along different path lengths, characterized by different time delays, and combining the signals in the communication link.

10. The method of claim 7, comprising using a plurality of different signals for communicating with the user along different path lengths, and combining the signals in the communication link.

11. The method of claim 7, wherein a MIMO communications mode employs the diversity at both ends of the communication link, thereby improving the reliability and increasing the capacity of the communications link.

12. The method of claim 7, comprising employing phase diversity, frequency diversity, temporal diversity, interleaving diversity, polarity diversity or a combination thereof, the using of the combined signals combining the signals exhibiting the diversity.

13. The method of claim 1, comprising employing phase diversity, frequency diversity, temporal diversity, interleaving diversity, polarity diversity or a combination thereof, the using of the combined signals combining the signals exhibiting the diversity.

14. The method of claim 1, comprising:
responding to one of a signal quality below a predetermined threshold or the comparison of the signal propagation pathways in the communication link by providing an indication to the user of low signal quality; and
varying the indication to the user, wherein a change in a signal metric related to signal quality results in a change in the indication to the user perceptible by the user, thereby providing the user with an indication for positioning the WCD in a manner to improve the signal quality.

15. A wireless communication device (WCD) for use in satellite communication, the WCD comprising:
at least two antennas;
a radio frequency (RF) circuit that establishes a communication link through at least one of the at least two antennas;
a circuit that obtains a comparison of a measured signal quality through at least two signal propagation pathways in the communication link as obtained by switching between the at least two antennas; and
an antenna switching circuit that switches between the at least two antennas by connecting the circuit that establishes a communication link to the antennas and switching between the antennas responsive to a comparison of the measured quality to switch to an antenna deemed optimum in accordance with the measured signal quality.

16. The WCD of claim 15, further comprising a circuit, receiving the comparison of the measured signal quality, capable of selecting one of the signal propagation pathways in accordance with the measured signal quality.

17. The WCD of claim 15, further comprising:
a circuit, receiving the comparison of the measured signal quality, capable of selecting one of the signal propagation pathways in accordance with the measured signal quality; and
the receiving the comparison of the measured signal quality provided on the user's WCD.

18. The WCD of claim 15, further comprising a circuit, receiving the comparison of the measured signal quality, capable of selecting one of the signal propagation pathways in accordance with the measured signal quality.

19. The WCD of claim 15, further comprising:
a circuit, receiving the comparison of the measured signal quality, capable of selecting one of the signal propagation pathways in accordance with the measured signal quality; and
the circuit capable of selecting one of the signal propagation pathways provided on the user's WCD.

20. The WCD of claim 15, further comprising:
a circuit that obtains a measured signal quality in the communication link and determines if the measured signal value falls below a predetermined threshold indicating low signal quality; and
a circuit that provides an indication to the user of the low signal quality, wherein a change in a signal metric related to signal quality results in a change in the indication to the user perceptible by the user, thereby providing the user with an indication for positioning the WCD in a manner to improve the signal quality.

21. The WCD of claim 15, further comprising:
a circuit that obtains a measured signal quality in the communication link and determines if the measured signal value falls below a predetermined threshold indicating low signal quality; and
a circuit, responsive to the circuit that obtains a measured signal quality and the circuit that obtains a comparison of a measured signal quality, providing an indication to a user, wherein a change in a signal metric related to signal quality results in a change in the indication to the user perceptible by the user, thereby providing the user with an indication for positioning the WCD in a manner to improve the signal quality.

22. A satellite communication station for communicating with a plurality of subscribers, the communication station comprising:
a circuit that establishes a communication link with a user's wireless communication device (WCD);
a circuit that obtains a comparison of at least two signal propagation pathways by one of comparing at least two signal propagation pathways in the communication link, or by requesting a comparison of at least two signal propagation pathways in the communication link and receiving the comparison; and
a circuit that selects one of the signal propagation pathways in accordance with a measured signal quality, and communicating the selection to the user's WCD.

23. The communication station of claim 22, wherein the user's WCD provides the comparison of the signal propagation pathways by selecting an antenna on the WCD.

24. A circuit device for use with a satellite communication system, the circuit device comprising:
means for establishing a communication link;
means for comparing at least two signal propagation pathways in the communication link; and
means for selecting one of the signal propagation pathways in accordance with a measured signal quality.

25. The wireless communication device of claim 24, further comprising the means for selecting the signal propagation pathways including an antenna selection circuit for selecting an antenna for use on a user's wireless communication device (WCD), and effecting the selection through the WCD.

26. The wireless communication device of claim 24, comprising:
means for receiving a signal from a user's wireless communication device (WCD);
means for determining a signal quality value from a first signal from the WCD and in the case of the signal quality value having a value below a predetermined threshold, issuing a low signal value message;
means for receiving a subsequent signal from the WCD;
means for comparing and selecting the signals in accordance with the signal quality value; propagation pathways by selecting an antenna on the user's WCD; and
means for effecting the selection through the WCD.

27. The wireless communication device of claim 26, further comprising:
means, responsive to the means for determining a signal quality, for providing an indication to the user of low signal quality; and
means for providing a variation in the indication to the user, wherein a change in a signal metric related to signal quality results in a change in the indication to the user perceptible by the user, thereby providing the user with an indication for positioning the WCD in a manner to improve the signal quality.

28. The wireless communication device of claim 24, further comprising means for combining received signals in the communication link and using the combined signals in the communication link.

29. The wireless communication device of claim 28, comprising means for using a plurality of different signals for communicating with the user along different path lengths, characterized by different time delays, and combining the signals in the communication link.

30. The wireless communication device of claim 28, comprising means for combining received signals in the communication link and employing phase diversity, frequency diversity, temporal diversity, interleaving diversity, polarity diversity or a combination thereof, the using of the combined signals combining the signals exhibiting the diversity.

31. A wireless communication device (WCD) for use in satellite communication, the WCD comprising:
a circuit that obtains a measured signal quality in a communication link;
a circuit that determines if the measured signal value falls below a predetermined threshold indicating low signal quality; and
a circuit that provides an indication to the user of the low signal quality, wherein a change in a signal metric related to signal quality results in a change in the indication to the user perceptible by the user, thereby providing the user with an indication for positioning the WCD in a manner to improve the signal quality.
